(19) United States
(12) Patent Application Publication
(10) Pub. No.: US 2021/0405250 A1
(43) Pub. Date: Dec. 30, 2021

(54) Conditioning of Surface-Based Geologic Models

(71) Applicant: 22777 Springwoods Village Parkway, Spring, TX (US)

(72) Inventors: John E. Mayhew, Spring, TX (US); Matthias G. Imhof, Katy, TX (US); Sha Miao, Spring, TX (US); Ali Vaziriastaneh, Houston, TX (US)

(21) Appl. No.: 17/304,470

(22) Filed: Jun. 22, 2021

Related U.S. Application Data
(60) Provisional application No. 62/705,396, filed on Jun. 25, 2020.

(51) Int. Cl. G01V 99/00

(52) U.S. Cl. CPC G01V 99/005

(57) ABSTRACT

A method for conditioning of surface-based geological models is provided. Surface-based geological models seek to represent a portion of the subsurface while honoring the available data. However, conditioning of surface-based geological models may be challenging particularly for situations where the geologic elements, such as lobes or channels, are interspersed with another geological element, such as impermeable mud. To condition the geological model, muds are specified through a mud trend or a set of specified mud layers. For example, each mud layer provides the environment of the geological element, such as the lobe to rest on or the channel to erode into. The surface-based geological model may then be built by sequential conditioning layer by layer, such as bottom upward. In this way, the mud layers provide context in which to place objects during conditioning to better generate the surface-based geological model.

### CROSS REFERENCE TO RELATED APPLICATIONS

This application claims the benefit of U.S. Provisional Application 62/705,396, filed Jun. 25, 2020, the entirety of which is incorporated by reference herein.

### TECHNICAL FIELD

This disclosure relates generally to the field of geophysical prospecting for hydrocarbon management and related data processing. Specifically, exemplary implementations relate to methods and apparatus for conditioning surface-based geological models.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Surface-based, event-based, or functional-form geologic elements represent spatial configurations that have been created by a geological process in which the individual depositional or erosional events are easily identifiable. This results in complex layered configurations that may be carbonaceous, clastic, or even magmatic in composition. While surface-based models do not aim to be physically realistic, they yield realistic geometries generated by such processes. In this way, surface-based models aim to mimic the end result created by physics-based process models at a fraction of the computational time. Deepwater sedimentary systems, which may comprise lobes and channels, are excellent candidates for surface-based modeling.

For reserve or production prediction, the generated geologic model should honor available data, such as relevant concepts, wireline data, or seismic data. Traditional cell-based geologic modeling methods, such as based on geostatistics or variograms, allow constraining the geologic models to the wireline data or seismic data, albeit by sacrificing geometry, connectivity, and geologic appearance. In this regard, conditioning of the surface-based models may be challenging.

### SUMMARY

A computer-implemented method of conditioning surface-based geologic models of a subsurface is disclosed. The method includes: accessing an indication of a plurality of mud layers in the subsurface; conditioning, using the indication of the plurality of mud layers, by emplacing at least one of lobes or channels; and building a model based on the conditioning.

### DESCRIPTION OF THE FIGURES

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a flow diagram of an example conditioning methodology segmented into multiple steps.

FIG. 2 is a flow diagram of a first example of sequential conditioning.

FIG. 3A is a flow diagram of a first implementation of the sequential conditioning depicted in FIG. 2.

FIG. 3B is a flow diagram of a second implementation of the sequential conditioning depicted in FIG. 2.

FIG. 4 is a flow diagram of a second example of sequential conditioning.

FIG. 5A is a depiction of lobes emplaced onto a predefined mud trend via sequentially conditioning bottom-up.

FIG. 5B is a first depiction of channels emplaced onto a predefined mud trend via sequentially conditioning top-down.

FIG. 5C is a second depiction of channels emplaced onto a predefined mud trend via sequentially conditioning bottom-up by flipping about the z-axis.

FIG. 5D is an example illustration of a FilITo surface.

FIG. 5E is an example illustration of a drape surface.

FIG. 5F is an example illustration of an erosional surface.

FIG. 6 is a depiction of a concept model, mud trend, proportion trend, and wells, and a plurality of candidate lobes that may be compatible with the mud trend, proportion trend, and wells.

FIG. 7A is a first depiction of the mud layers (with a flat orientation and uniform thickness) and lobes.

FIG. 7B is a second depiction of the mud layers (with a slightly tilted orientation and uniform thickness) and lobes.

FIG. 7C is a third depiction of the mud layers (with a more tilted orientation and uniform thickness) and lobes.

FIG. 7D is a fourth depiction of the mud layers (with a flat orientation and uniform thickness) and lobes.

FIG. 8A is a depiction of the mud layers with varying orientation and non-uniform thickness.

FIG. 8B is another depiction, similar to that illustrated in FIG. 8A, with additional dashed lines to highlight the changes in the mud layers.

FIG. 9 is a diagram of an exemplary computer system that may be utilized to implement the methods described herein.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image, or geophysical or seismic inversion results) or interpretation quantities, including geophysical properties such as one or more of: elastic properties (e.g., P and/or S wave velocity, P-Impedance, S-Impedance, density, attenuation, anisotropy and the like); and porosity, permeability, clay or shale proportion, net-to-gross ratio, or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (i.e., acoustic) data sets in conjunction with other geophysical data, including, for example, gravity plus seismic; gravity plus electromagnetic plus seismic data, etc. For example, joint-inversion utilizes multiple geophysical data types.

The term “wireline data” as used herein broadly means any data received and/or recorded via wirelines, or generally, any data acquired from within a borehole. For example, wirelines may comprise cabling technology used by operators to lower equipment or measurement devices, such as wireline tools, into a well for any of the following purposes: reservoir evaluation; well intervention; or pipe recovery. Various wireline tools may be used, such as any one, any combination, or all of: natural gamma ray tools; nuclear tools; resistivity tools; sonic and ultrasonic tools; nuclear magnetic resonance tools; borehole seismic tools; or cased hole electric line tools. In one practice, the wireline is an electrical cable used to lower tools into and transmit data (which may be termed wireline logs) about the conditions of the wellbore. In another practice, logging tools may be incorporated in the drill pipe assembly to measure while drilling.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

Subsurface model is a numerical, spatial representation of a specified region in the subsurface.

Geologic model is a subsurface model that is aligned with specified faults and specified horizons.

Reservoir model is a geologic model where a plurality of locations have assigned properties including rock type, environment of deposition (EOD), subtypes of EOD (sub-EOD), porosity, permeability, fluid saturations, etc.

For the purpose of the present disclosure, subsurface model, geologic model, and reservoir model are used interchangeably unless denoted otherwise.

Stratigraphic model is a spatial representation of the sequences of sediment and rocks (rock types) in the subsurface.

Structural model or framework results from structural analysis of reservoir based on the interpretation of 2D or 3D seismic images. For example, the reservoir framework comprises horizons, faults and surfaces inferred from seismic at a reservoir section.

Conditioning data refers a collection of data or dataset to constrain, infer or determine one or more reservoir or stratigraphic models. Conditioning data might include geophysical models, petrophysical data, seismic images (e.g., fully-stacked, partially-stacked or pre-stack migration images), seismic inversion results, well log data, wireline data, production data and structural framework. In this regard, conditioning geological models may comprise matching one, some, or all of the structural geometry (such as horizon, faults, etc.), stratigraphic geometry (such as high-resolution layering and adherence to geologic bodies) and the properties (e.g., interpreted, inferred, or measured properties). As discussed further below, the conditioning process, which is executed on a computer, may be performed sequentially (e.g., matching geometrical information first and thereafter the properties) or simultaneously (e.g., matching both geometrical information and the properties concurrently). Conditioning may be performed sequentially, e.g. bottom-up, left-to-right, or east-to-west; or globally or simultaneously by matching information from a plurality of locations and updating a plurality of locations or parameters simultaneously.

Various geological bodies are contemplated. In particular, different depositional environments may result in different types of geological bodies. Each depositional environment creates its own set of geological bodies. Examples include channels and lobes. Additional examples include a fluvial depositional environment with braided channels, anastomosing channels, meandering channels, overbank or floodplain deposits; a deep water environment with distributed or confined channels, levees, lobes, spills, and overbank deposits; a shallow water environment with depositional endmembers of a tidal-dominated delta, a fluvial-dominated delta, a current-dominated delta, containing channels, beaches, bars, clinoforms, marshes, dunes, tidal flats, lagoons, and barrier islands; Aeolian environments with sand dunes; playa environments with salt lakes, evaporites, or dunes; lake environments with lake deposits, mud slides, and marshes; alluvial fan environments with mud slides, landslides, and alluvial fans; carbonate environments with reefs, beaches, platforms and many elements already described.

For the exemplary deepwater environment, the geological body may comprise channels/lobes, channels, lobes, levees, or the like. In this regard, any discussion regarding channels/lobes, may be applied to a geological body including channels/lobes, channels, lobes, levees or any other type of geological body. Any discussion regarding geological bodies or elements may be applied to bodies occurring in other depositional environments or configuration like a channel, a lobe, a carbonate reef, a tidal-dominated delta, a fluvial-dominated delta, a current-dominated delta, or another geologic configuration into a geologic model.

Machine learning is a method of data analysis to build mathematical models based on sample data, known as training data, in order to make predictions and/or decisions without being explicitly programmed to perform the tasks.

Machine learning model is the mathematical representation of a process, function, distribution or measures, which includes parameters determined through a training procedure.

As used herein, “hydrocarbon management” or “managing hydrocarbons” includes any one or more of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, conditioning of surface-based models may be difficult, such as, for example, because surfaces may be emplaced in an order and surfaces may be generated by an equation or functional form. Specifically, a surface may be placed on the earlier-placed surfaces, and thus, the later surface may be affected by earlier-placed surfaces. When an earlier-placed surface is modified, all later ones may shift and may thus need updating. Moreover, the surface equation or functional form may be simplistic and idealistic, yet may contain nuisance parameters that may be difficult to specify or estimate.

Further, it may be particularly difficult to model and condition in situations where the geologic elements (e.g., lobes or channels) are interspersed in another geologic element, such as in impermeable mud. For example, if there are less than a first percentage (e.g., 30%) lobes or channels, then the lobes and channels are essentially swimming in mud in isolation, being disconnected from each other. If there are more than a second percentage (e.g., 70%) lobes or channels, then the lobes and channels are mostly connected to each other. For lobe and channel fractions between 30 and 70%, placement details may matter.

However, modeling mud and channel/lobes simultaneously may be difficult since muds may not be easily represented in functional form because their geometries vary greatly. As one example, modeling mud and channel/lobes simultaneously may necessitate specificity of the parameters for the representative equations or functional forms. However, sufficient information on the mud to specify the parameters may be unavailable, resulting in overly simplistic representations. As another example, the mud may be treated as another object (akin to the channels/lobes). Again, defining a separate mud object may require defining too many parameters, and may make optimization (with yet another type of object) more difficult. As a result, it may be difficult to define all of the volumes simultaneously (e.g., filling the subsurface with the right proportions of mud/channels/lobes). Further, in one embodiment, a functional mud drape may be attached to each functional channel/lobe; however, filling the model with a specified channel/lobe fraction is difficult because muds and non-muds may be coupled and underfill or overfill may occur. Thus, simultaneously attempting to condition both the mud of the background and the objects in the mud (e.g., channels/lobes) may be excessively difficult.

Thus, in one or some embodiments, a mud background may be defined, and may be used to emplace objects (e.g., channels/lobes) that are subject to conditioning. As discussed in more detail below, in one or some embodiments, the conditioning comprises sequential conditioning depending on the mud background (e.g., the mud background is defined layer by layer and/or by sets of layers, with sequential conditioning being performed layer by layer, by sets of layers, or by layers and sets of layers). Alternatively, the conditioning may be non-sequential while still using the mud background.

Generally speaking, the mud background, in and of itself, is not the focus of conditioning the surface-based geological model. In particular, hydrocarbons are not produced from the mud, and the mud is ultimately not of interest in the model. In this regard, the mud background may be defined with sufficient specificity in order to provide the basis in which to emplace the objects of interest, including the channels/lobes, for conditioning but need not be defined with sufficient specificity to model the mud in and of itself.

As discussed in more detail below, the mud background may be defined in one of several ways. In one or some embodiments, muds are specified through a mud trend or a set of specified mud layers. For example, a mud model may describe one or more aspects of the mud background including one or more layers of the mud model. As discussed in more detail below, the layers may be uniform in all aspects (e.g., the thickness of the layers is uniform), may be non-uniform in one or more aspects, or may be partially uniform and partially non-uniform. In this regard, the mud may be defined layer by layer and/or by sets of layers. Further, the mud model may be manifested in one of several ways, such as represented as a set of surfaces or represented as a surface based model (e.g., with one or more properties, such as any one, any combination, or all of: one or more channel/lobe aspects (e.g., target or actual channel/lobe fractions); environment of deposition; sub environments; facies; etc.).

In this way, one, some, or each mud layer may provide the base for a lobe to rest on or a layer for a channel to erode into. The model may thereafter be built upward, such as from the bottom layer upward to the upper layers. A similar methodology may be used for channels. For example, beginning with a mud layer, as many channels as needed may be eroded into this layer and the existing stack of mud, channels, and lobes below. Channel placement may be guided by expected channel fraction as well as wireline and seismic data. Then, the next mud layer is placed on top and the process is repeated.

In effect, the mud layers provide context in which to place objects during conditioning, as discussed further below. As one example, lobes may be placed on the mud layer (to the extent the data indicates such) instead of simply stacking lobes on top of one another. In this way, the mud may be used to fill space in between different lobes. As another example, channels may have the mud layers through which to dig into. This is in contrast to the traditional approach, which was to place channels/lobes into a void, which failed to account for the background mud.

In this regard, the mud background may be defined in one or more aspects, such as thicknesses, shapes, trends, orientations, or the like. The selection of the mud background may influence the final surface-based geologic model. Thus, various mud backgrounds (e.g., different orientations, different dips, different correlations, different well ties, etc.) may be used to generate different surface-based geologic models, thereby enabling exploration of different realizations or scenarios (particularly where the data on the mud background may be limited).

Further, as discussed in the background, the surface-based models aim to yield realistic geometries, but do not aim to be physically realistic or to be created by a physics-based process (instead opting to be built at a fraction of the time). In this regard, previous surface-based models attempted to solve the subsurface as a whole. In contrast, in one embodiment, sequential conditioning, such as layer-by-layer (and element-by-element within a respective layer) and/or by sets of layers, is performed. Specifically, with the defined mud background, sequential conditioning of the objects (e.g., the lobes/channels) may occur from lower layers to higher layers (e.g., from the bottom layer upward). For example, within a respective layer, objects or elements may be emplaced sequentially, thereby allowing for determination of element or object parameters one element at a time rather than having to determine the parameters for all elements or objects simultaneously. This may result in one or both of the following benefits: (1) dividing the overall conditioning problem into more manageable pieces; and (2) more faithfully following the actual geology (e.g., whereby layers are built on top of one another over time or channels bore into the subsurface over time).

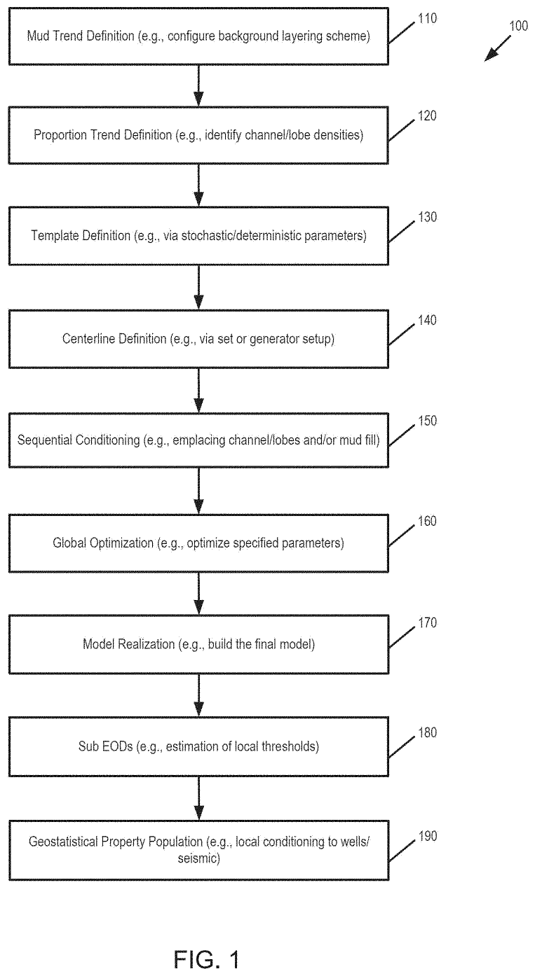

Referring to the figures, FIG. 1 is a flow diagram 100 of an example conditioning methodology segmented into multiple steps. In particular, flow diagram 100 includes: mud trend definition 110; proportion trend definition 120; template definition 130; centerline definition 140; sequential conditioning 150; global optimization 160; model realization 170; sub EODs 180; and geostatistical property population 190. In one or some embodiments, all of the steps illustrated in FIG. 1 are performed. Alternatively, fewer than all of the steps illustrated in FIG. 1 are performed. As one example, only mud trend definition 110, proportion trend definition 120, template definition 130, and sequential conditioning 150 are performed. In this regard, any one, any combination, or all of the steps illustrated in FIG. 1 may be performed. Further, FIG. 1 illustrates a sequence of steps to be performed. The sequence illustrated is merely for purposes of example. Other sequences are contemplated.

Thus, FIG. 1 illustrates separate steps, such as mud trend definition 110, proportion trend definition 120, template definition 130, centerline definition 140, etc. that enable better control by the modeler. This is in contrast to previous solutions, which in effect comprised a black box, resulting in great difficulty by the modeler to tune the black box. As discussed above, the modeler may investigate different potential realizations or scenarios by tuning the various definitions, resulting in different surface models generated and having a better understanding of the risks and uncertainties in the modeling.

Mud trend definition 110 is configured to create the background layering scheme (e.g., the mud layers for lobes to rest on or channels to erode into). In one embodiment, mud layers of a constant thickness are specified to follow the base of the model. In another embodiment, mud layers of a constant thickness are specified to follow the top of the model. In still another embodiment, a specified number of mud layers are placed to proportionally follow the model base and top. Multiple scenarios may be created by definition of different mud trends and conditioning to a plurality of such trends.

In one or some embodiments, mud layers are given as a set of surfaces. Alternatively, the mud trend is represented as a second surface-based model. It is advantageous to attach properties like target or actual channel/lobe fractions, environment of deposition, sub environments, facies, etc. to this second surface-based model. Rather than providing second surface-based models, in one or some embodiments, voxelized models may be used as a mud model in which mud layers may be represented by isosurfaces or isoregions of a property attached to this voxel-based model. Exemplary properties include one or both of a layer-identifier property or a region-identifier property. Each voxel may have additional properties assigned to it, e.g., target fraction, environment of deposition, sub environments, facies, etc.

Proportion trend definition 120 comprises defining fractions or densities of lobes, channels, muds, and other elements. For example, the percentage of lobes and channels in the impermeable mud may be defined, such as discussed above. Densities may be defined in one of several ways, such as globally for the entire model (0D), vertically (1D), based on maps (2D), by map and vertical trend (2D×1D), or locally (3D). In some embodiments, 2D trend maps or 3D trend volumes are interpreted or derived from seismic data. In some embodiments, seismic data are segmented into polygonal regions that are associated with specified proportion values. In some embodiments, a vertical 1D trend is derived from one or multiple wells. In some embodiments, proportion trends may be used to specify convergence criteria during sequential-conditioning 150. Further, in one or some embodiments, proportion trends may be attached to the second surface-based mud-trend model, for example, as properties of the mud-trend model. In an alternate embodiment, net-to-gross targets are provided rather than element fractions, densities, or proportions. Net-to-gross targets convolve element density with lithology distributions inside the elements to form a non-mud fraction. Multiple scenarios may be created by definition of multiple, different targets and fractions and condition to a plurality of trends, targets and/or fractions.

The elements, such as channels and/or lobes, may be defined in one of several ways. As one example, a functional form, which may comprise one or more mathematical equations, may be used to define the channel and/or the lobe. The functional form may include free parameters, with values specified for these free parameters allowing for evaluation of the functional form equation. Various parameters, such as centerline (e.g., shape, location, orientation), element shape along a centerline, element shape perpendicularly across a centerline, thickness, width, length, etc., are contemplated. For example, Xiuli Gai, Xiao-Hui Wu, Bogdan Varban, Kathryn Sementelli, Gregory Robertson, “Concept-Based Geologic Modeling Using Function Form Representation”, Society of Petroleum Engineers, SPE-161795-MS, pg. 2678-2690, Abu Dhabi International Petroleum Conference and Exhibition (2012), which is incorporated by reference herein in its entirety, discloses example parameters. In one or some embodiments, the fully parameterized equation without any remaining free parameters (e.g., based on a template definition, see below) may be used to instantiate or realize a surface that may be used in a surface-based model.

Template definition 130 may comprise specification of explicit values or distributions for the free parameters of a functional form. In one embodiment, each element may be parameterized individually. Alternatively, a set of elements may be parameterized by definition of a parameter template for the set of elements. In one embodiment, the template may be deterministic with explicit values assigned to parameters. A functional form equation may thus be instantiated or realized by assigning the values from the deterministic template to the free parameters. In another embodiment, the template may be stochastic with parameters associated with distributions (e.g., min-max, uniform, triangular, normal, etc.).

In one embodiment, the functional form equation may be instantiated by drawing values from the stochastic template distributions and assigning those values to the free parameters. Thus, in one embodiment, the template may have stochastic elements. In another embodiment, the template may have deterministic elements. In still another embodiment, the template may have both deterministic and stochastic aspects. Further, the templates may be defined in one of several ways. In one way, the templates may be defined by a user based on any one, any combination, or all of: data interpretation; data bases; reported literature values; analogues: or experience. In addition, in one or more embodiments, the templates may be prepopulated with default values. In one or some embodiments, the template may be selected from a plurality of default templates. In one or more embodiments, different scenarios may be generated by definition of multiple templates and conditioning to a plurality of these templates.

The instantiated model element may be placed in one of several ways. One way to place the instantiated element is by using centerline definition 140. For example, in one or some embodiments, functional forms may use centerlines or polylines to guide any one, any combination or all of: location of the instantiated element; orientation of the instantiated element; and shape of the instantiated element. In this regard, centerline definition 140 is merely one example of a position definition methodology in which to place the instantiated element. Other ways to define positioning (using other types of position definitions) of the elements, separate from or in addition to using centerlines, is contemplated.

Centerline definition 140 may comprise specification of centerlines for instantiated elements. Centerlines may comprise a line through the center of an object, such as a channel or a lobe, and may represent one manner in which to define a respective channel or lobe. In this regard, centerline parameters may be optimized instead of or in addition to optimizing other lobe/channel parameters. Further, the number of centerlines may be determined from the provided proportions constraints. Alternatively, the number of centerlines may be fixed (e.g. when not conditioning to proportions). In addition, centerlines may be changed stochastically, thereby providing several realizations that may equally match well logs and proportions.

For example, in one embodiment, a user may provide an explicit set of centerlines, such as based on interpretation of seismic data. In another embodiment, a centerline generator may be used to instantiate or draw a plurality of centerlines. The centerline generator may be guided by any one, any combination, or all of: specification of start and/or finish lines; specification of fairways (e.g., lateral boundaries); target points for intersection or repulsion; or drawing/repulsing centerlines to/from certain areas on a map. Multiple scenarios may be generated by definition of multiple centerline sets or generators and conditioning to a plurality of these centerlines and/or generators.

Centerlines may be parameterized by specification of sinuosity, wavelength, amplitude, etc. In one or some embodiments, the centerline generator is configured to generate a centerline and to accept or reject the generated centerline. As one example, the centerline generator may perform a quality check of the generated centerline in order to determine whether to reject the generated centerline (e.g., a topological analysis of a polyline to determine whether there's an intersection). In one example, the centerline generator may reject a centerline for self-intersection, such as when a channel cuts back on itself so that the channel, in effect is going backwards and intersecting itself.

In one or some embodiments, the current state of the surface-based model inside the sequential conditioning block 150 may be used to control the centerline generator. In one or some embodiments, the current top surface of the model is analyzed to route centerlines to a local minimum (e.g., a local depression in the current model). In another embodiment, the centerline is routed to the global minimum of the current top surfaces. In some embodiment, centerlines are routed through a sequence of local extrema of the current top surface. In some embodiments, a specified centerline is distorted by any one, any combination, or all of translation, rotation, and scaling to start, terminate or pass through a specified location. In another example, a custom centerline is generated from a set of specified points (e.g., starting point, terminal point at an identified minimum, and intermediate points selected at random, at specified locations, or at local minima) by construction and perturbation of a Bezier spline. Further, in one or some embodiments, the centerline generator is configured to place centerlines preferably into low spots of the current surface-based model in order to mimic compensational stacking. For example, a probability map is generated based on the current top surface height with higher spots having lower probability. The centerlines with lower probability scores at lobe centers are not considered for the sequential conditioning at this layer. In some embodiments, centerlines with lower probabilities integrated along their path are not considered. In some other embodiments such as erosional systems, the centerline generator can be configured to shift the centerlines laterally by a random distance to mimic channel lateral migration. In another embodiment, the centerline generator provides a sequence of correlated centerlines an example of which can be found in U.S. Pat. No. 8,892,412.

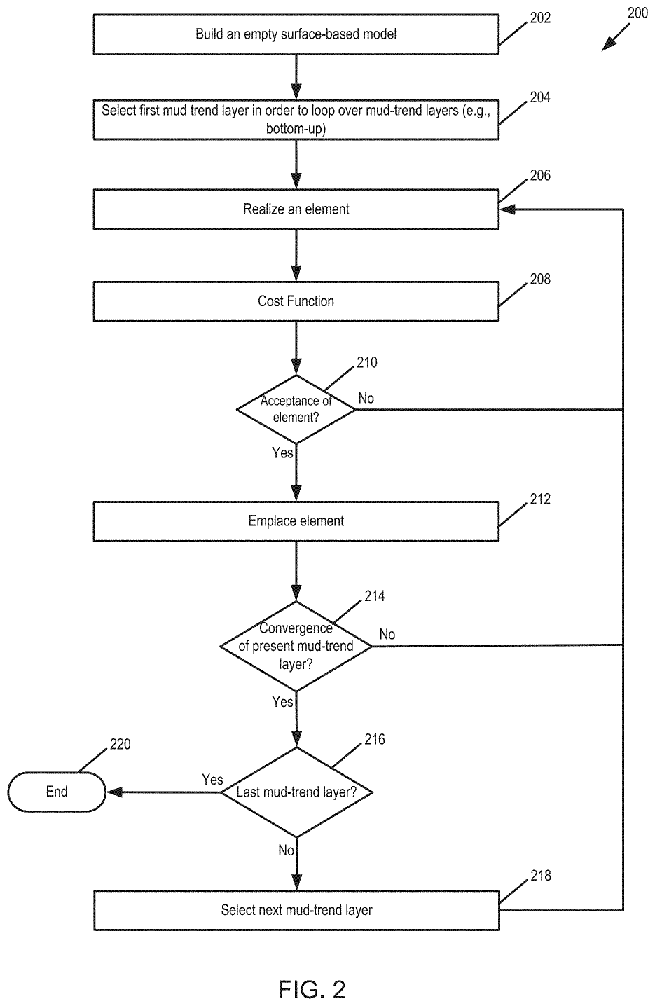

Sequential conditioning 150 comprises placing elements into the surface-based model that honor specified constraints, such as any one, any combination, or all of: wireline data; seismic data; or specified proportions. In one or some embodiments, elements are emplaced sequentially, thereby allowing determination of element parameters one element at a time rather than determining the parameters for all elements simultaneously, as discussed, for example, in FIG. 2 below. This is in contrast to simultaneous estimation of parameters for multiple elements, which may comprise a global nonlinear optimization that may be computationally expensive. Moreover, a global nonlinear inversion may become trapped in a local minima unless a good starting point is provided.

In one or some embodiments, sequential conditioning 150, which may optimize layer-by-layer and/or element by element, may obviate the need for subsequent global optimization 160. Alternatively, the sequential conditioning 150 may provide a starting model for subsequent global optimization 160. In particular, the element parameters determined by sequential conditioning 150 may be used as initial parameters in global optimization 160 to further refine the model. In one embodiment, global optimization 160 may be performed automatically after performing sequential conditioning 150, such as performing global optimization across multiple mud layers. In one embodiment, global optimization is performed when a specified number of mud layers has been emplaced, for example for all elements emplaced in the last mud layer or within a specified number of recently placed mud layers. Alternatively, global optimization 160 may be performed dependent on the outcome of the sequential conditioning 150. For example, global optimization 160 may be performed based on analysis of the amount of misfit stacked as the layers are conditioned. In particular, responsive to determining that the misfit in performing the layer optimization is greater than a predetermined amount, global optimization 160 may be performed for the elements of one, multiple, select, or all mud layers.

The element parameters determined by sequential conditioning, and refined by global optimization for some embodiments, may be used to build the final model realization 170. For geologic realism, the final model realization 170 may be built bottom-up independent of whether the sequential conditioning 150 iterated over the mud layers bottom-up or top-down. In one or some embodiments, this final model may be distorted, such as distorted locally by stretching and squeezing to snap the elements and/or the mud layers to their respective well markers. In some embodiments, the final model may be faulted by cutting and displacing the parts and/or folded by deforming base and top surface of the model.

Further, in one or some embodiments, functional form elements may be augmented with an internal, local coordinate system tied to the functional form. Such local coordinates may be used to define properties and/or property variations inside the element. The interior of the lobe element, for example, may be segmented into the Sub Environments of Deposition (sub EODs) 180; proximal lobe, medial lobe, and distal lobe. Similarly, channel levee(s) may be decomposed into proximal levee, medial levee, distal levee, and overbank based on local coordinates. In one or some embodiments, sub EODs may be ignored. Alternatively, sub EODs are assigned by specified local-coordinate thresholds. In one embodiment, local coordinates are defined along the centerline, perpendicular to the centerline, and in the vertical direction. In another embodiment, local coordinates are define along the centerline, distance from a specified point, e.g. the element center, and the vertical direction. In one or some embodiments, sub EOD thresholds are determined by calibration with wireline and seismic interpretations.

In addition, model properties, such as any one, any combination or all of net-to-gross ratio, porosity, or permeability, may be assigned by element or local-coordinates within. It may be advantageous to normalize some or all local coordinates when using them to define properties or segment elements into sub units. Observed wireline or seismic data may exhibit high-frequency perturbations when compared to the properties determined from the element local coordinates. In this regard, in one or some embodiments, it may be warranted to perform geostatistical property population 190 in order to encode high-frequency perturbations resident in observed wireline or seismic data in the model properties of the model (e.g., stamp high-frequency perturbations resident in observed wireline or seismic data into the properties attached to the surface-based model). In one or some embodiments, geostatistical algorithms are used to match properties to wells and enforce the perturbation character away from well control.

Thus, the generated model may be used to generate any one, any combination, or all of result data, tables, spreadsheets, or image based thereon and to output the image onto a display. Further, the generated model may be used for managing hydrocarbons in the subsurface. For example, the model may be used for resource estimation, reservoir production simulation, or performance prediction.

FIG. 2 is a flow diagram 200 of a first example of sequential conditioning. At 202, an empty surface model is built. For example, sequential conditioning 150 may commence with an empty surface-based model and a fully formed mud-trend model (which may have been defined via mud trend definition 110, proportion trend definition 120, etc.). Flow diagram 200 may loop over a plurality (e.g., at least two) of the mud layers of the mud trend, such as looping over all mud layers of the mud trend. In this regard, conditioning may be performed sequentially at the layer level. In one or some embodiments, at each iteration of conditioning a respective mud layer, flow diagram 200 attempts to embed acceptable elements (e.g. lobes and/or channels) until a specified convergence criterion is met. When the iteration converges for the respective mud layer, the respective mud layer itself may be emplaced in the model at least partially covering the previously emplaced elements, and the algorithm may repeat at a next layer (such as repeating with the next-higher mud layer).

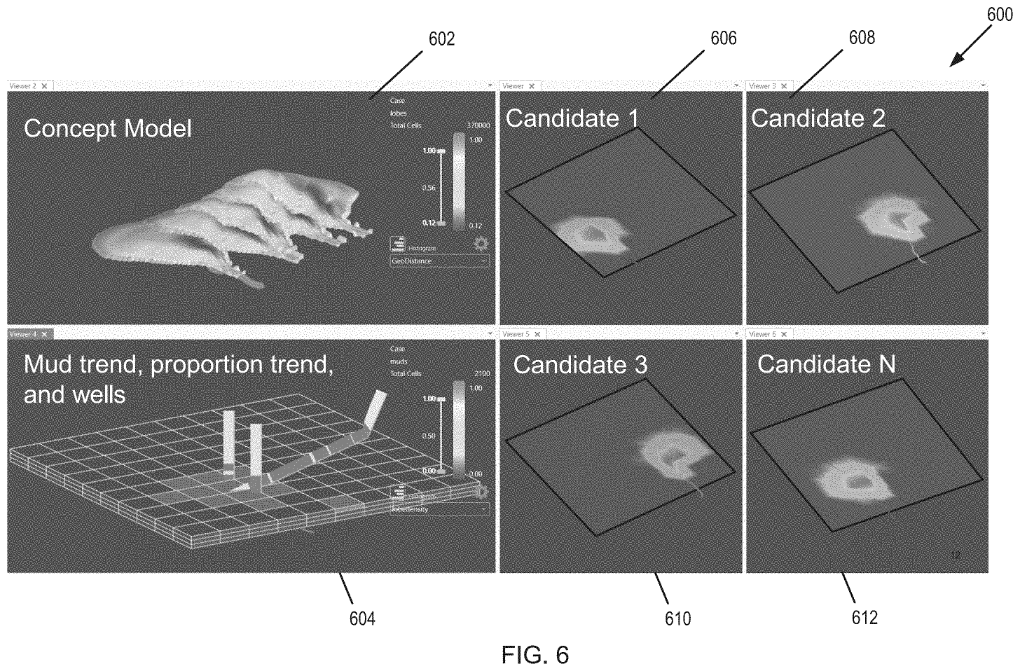

FIG. 2 illustrates one example of iterating over the respective layers. At 204, the first mud trend layer is selected in order to loop over mud-trend layers (e.g., bottom-up). Iterating over the mud-trend layers may reduce the large optimization problem into a sequence of smaller ones, such as one for each mud-trend layer. At 206, an element is realized, such as by using templates from the template definition 130 and the centerline generator from the centerline definition 140. In particular, various ways are contemplated in order to determine which elements to realize for consideration as to whether to emplace the realized elements. As one example, based on the mud trend model and available data, one or more elements may be identified as candidates for emplacing in the respective layer, such as illustrated in more detail in FIG. 6.

At 208, the realization of the element is assessed with a cost function, which may provide a measure of how well the realized element matches at least one of wireline data, seismic data, and desired target fraction. Within this disclosure, cost function is used equivalently to misfit function, loss function, likelihood function and others used to indicate a model fit. In one or some embodiments, the cost function is formed by weighted summation or ratio of multiple cost terms. For example, in one embodiment, a wireline cost term may count the number of EOD mismatches along the wells, while another wireline cost term may count the number of EODs not covered yet. In an alternative embodiment, a wireline cost function may be the total flexing depth of the element top surface in order to eliminate the EOD mismatch. In yet another embodiment, the wireline cost function may be the amount of distortion of element top and base needed to match, e.g., the EOD log. Alternatively, or in addition, the seismic data may be converted to a 3D density fraction and thus accounted for by the fraction term. For example, a seismic cost term may be the accumulated mean squared error over the covered layers within a map region or a model column.

At 210, it is determined whether to accept the realized element. In one embodiment, the element is considered acceptable if the element is the best among a set of candidate elements. In an alternate embodiment, elements with cost below a specified cost threshold are considered and a random draw is made to select the final candidate following simulated annealing method. In this way, the optimization search is less greedy, thus more likely to reach a global optimum. At 212, responsive to acceptance, the element is emplaced in the model. In some embodiment, if the wireline cost function is defined as the total flexing depth of the element top surface, optionally, the element top surface can be flexed after emplacement to uncover the mismatched EODs, leaving them to be matched by later elements. Alternatively, flow diagram 200 loops back to 206.

At 214, it is determined whether there is convergence of the respective mud-trend layer. For example, additional elements may be evaluated and potentially embedded until the convergence criterion for the current layer is met. In one or some embodiments, the criterion may be based on whether all wireline observations are satisfied. In a preferred embodiment, the criterion may be based on whether all wireline observations within the current layer are satisfied. In another embodiment, the criterion may be based on whether the desired element fraction for the current layer is met. In still an alternate embodiment, the criterion may be based both on satisfied well observations and met layer fraction. For example, since the well observations are “hard” data and layer fractions are “soft” data, the criterion may be done sequentially in two steps. The first step may only considers elements intersecting wells until the wireline data conditioning cannot be improved further, while the second step may only considers elements not intersecting wells until the desired layer fraction is met. When the current layer has converged, then the current mud layer itself is emplaced in the surface-based model and the process is repeated for the next layer. For example, if there is convergence of the present mud-trend layer, at 216, it is determined if it is the last mud layer. If so, at 220, flow diagram 200 ends. If not, 218 the next mud-trend layer is selected, and the process is repeated by iterating to another mud layer (e.g., iterating to a next respective mud layer that is directly above the current mud-trend layer). Alternatively, sequential conditioning may be performed with sets of mud-trend layers, or with one or more mud-trend layers interspersed with one or more sets of mud-trend layers.

Thus, in one embodiment, there may be one or more misfit functions to determine whether to emplace an element (see 210) and whether to emplace the layer (see 214) in order to move to the next layer. In this regard, the inquiry may determine whether one or more criteria is met for that section of the model. For example, a first cost/misfit function may be used to determine whether to emplace the lobe/channel and a second cost/misfit function to determine whether to emplace the present mud layer and loop to a different layer.

As discussed above, sequential conditioning may iterate through the mud layers. In one or some embodiments, the iteration through the mud layers may be top-down. Alternatively, the iteration through the mud layers may be bottom-up. For deposition-dominated models, it may be advantageous to iterate bottom-up as illustrated in FIG. 2. For models dominated by erosive channel elements, it may be advantageous to iterate through the mud layers top-down and removing the current mud-trend layer and everything above it after convergence. Iterating top-down further may favor emplacement of big channels. On the other hand, iterating bottom-up for channel-dominated models has its own advantages. It is geologically more correct. In addition, instead of emplacing the channel elements at each iteration, the mud layer can be emplaced first. Then the channel elements can be placed to erode into a fixed covered space until the global misfit cannot be improved further. Unlike the depositional model where every newly emplaced element covers previously uncovered space, necessitating constant change of the comparison region; the erosional model with bottom-up iteration optimizes on a fixed covered space. The misfit function and convergence criteria are thus more straightforward.

FIG. 2 illustrates elements are realized, analyzed and emplaced one element at a time. Alternatively, elements may be realized, analyzed and emplaced in combination, such as one or more sets of elements. Further, in one or some embodiments, sequential conditioning 150 of element realization, cost function, and acceptance evaluation may be replaced by a reinforcement learning algorithm. Specifically, reinforcement learning comprises machine learning directed to how software agents ought to take actions in the sequential conditioning in order to maximize a predefined goal, such as emplacing elements. The reinforcement algorithm may train an agent to find an acceptable next element given the current state of the model such that the cost function for the final model is minimized. The agent may be trained to build a model using extremal cost function (e.g., minimal cost function). The agent may be represented by a neural network and may be trained by building the entire model repeatedly.

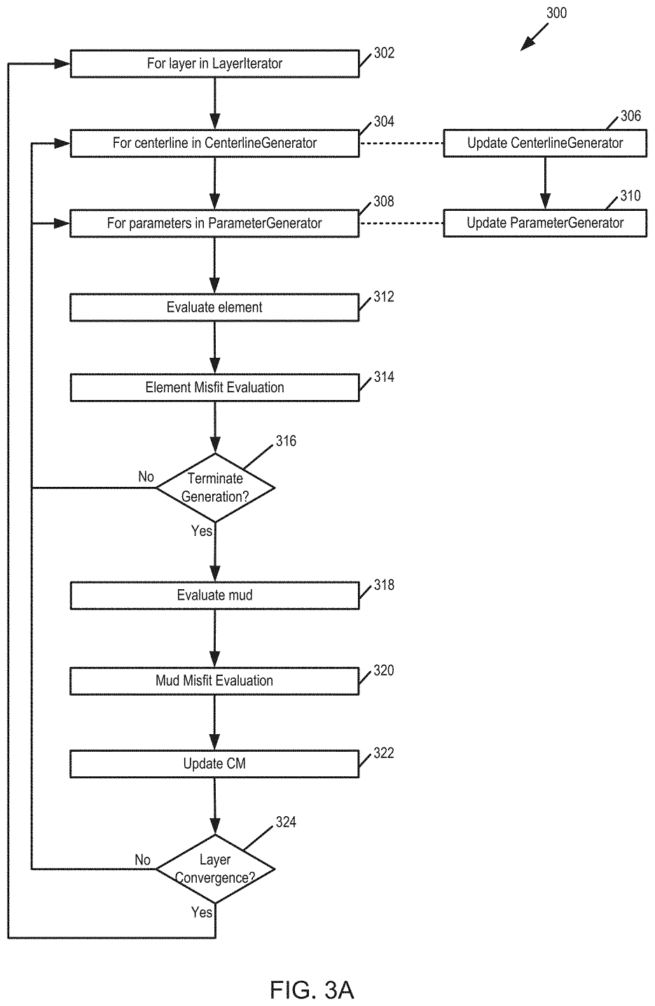

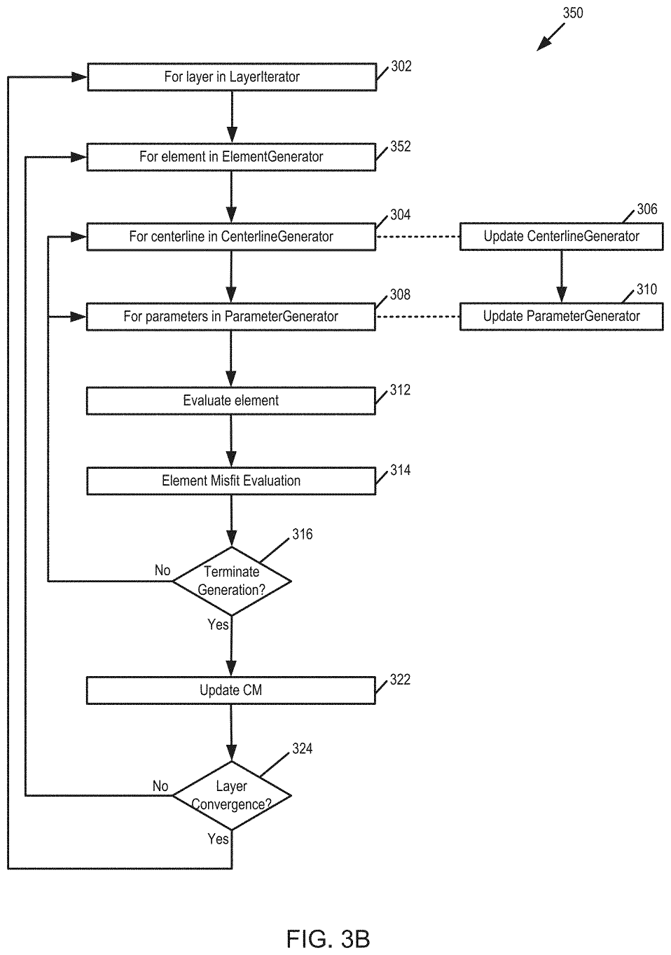

FIG. 3A is a flow diagram 300 of a first implementation of the sequential conditioning depicted in FIG. 2. At 302, Layerlterator may be set to the present layer. At 304, the centerline may be generated using CenterlineGenerator. The centerline may be pre-generated and accessed at 304. Alternatively, the centerline may be dynamically generated rather than accessed from a pre-generated set. In one embodiment, the CenterlineGenerator may be updated at 306 to generate centerlines preferentially compatible with the misfit 314. For example, element misfits are fed back to the CenterlineGenerator, enabling the generator to select, present, or generate centerlines more likely to yield favorable fits. In another embodiment, the CenterlineGenerator may be updated at 306 with the concept model 322, for example to route centerlines preferentially through the low spots of the current model. In a preferred embodiment, the dynamic CenterlineGenerator is updated with the topography of the current top surface of the concept model 322 to steer the centerlines toward the current topographic minima, using, e.g., a watershed algorithm. At 308, parameters may be generated using ParameterGenerator. As discussed above, the functional form may include free parameters, with values specified for these free parameters allowing for evaluation of the functional form equation. The parameters values may be pre-generated and accessed at 308. In another embodiment, the ParameterGenerator is not pre-populated with values, but with ranges or distributions and the generator 308 provides a value by drawing one from the range or distribution. In one embodiment, the ParameterGenerator provides the parameters of a deterministic template or draws parameters from a stochastic template. In yet another embodiment, the ParameterGenerator is updated at 310 to generate parameter values and resulting elements 423 that are preferentially compatible with the misfit 314. For example, element misfits are fed back to the ParameterGenerator, enabling the generator to select, present, or generate parameters more likely to yield favorable fits.

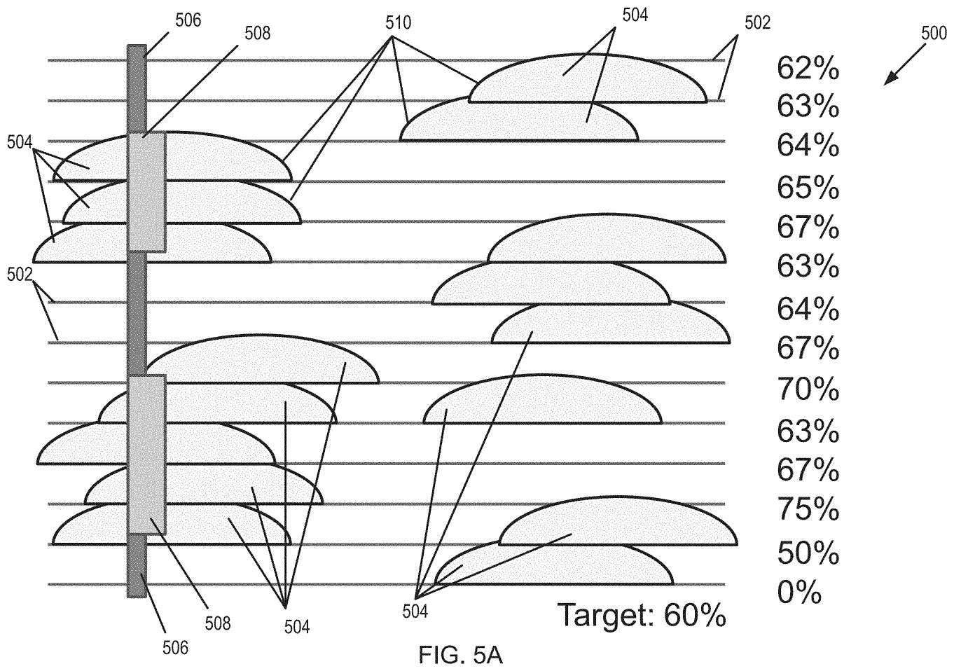

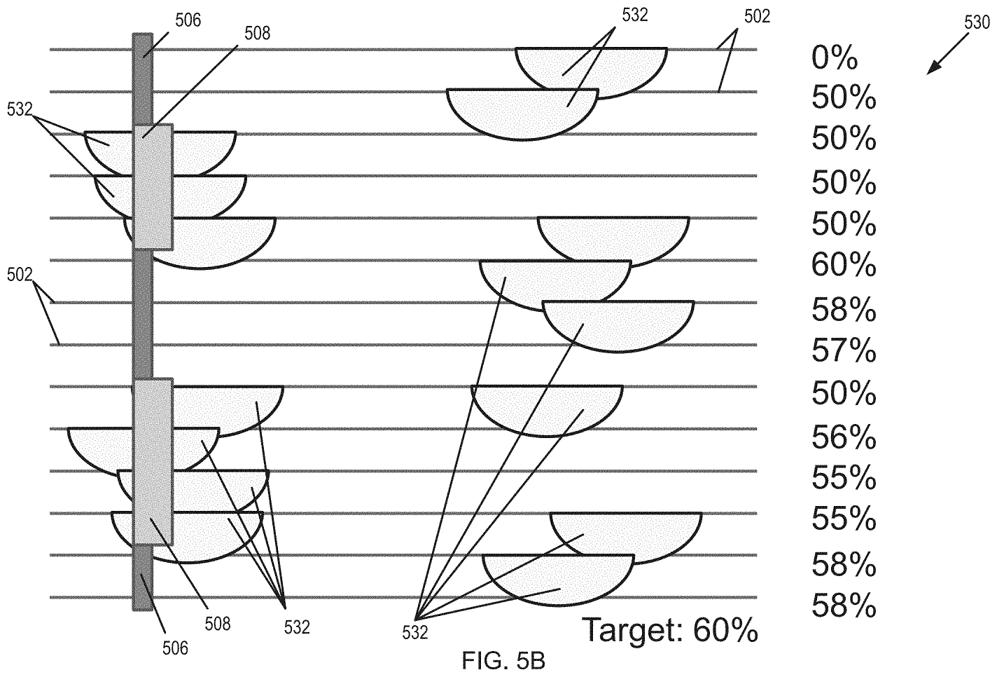

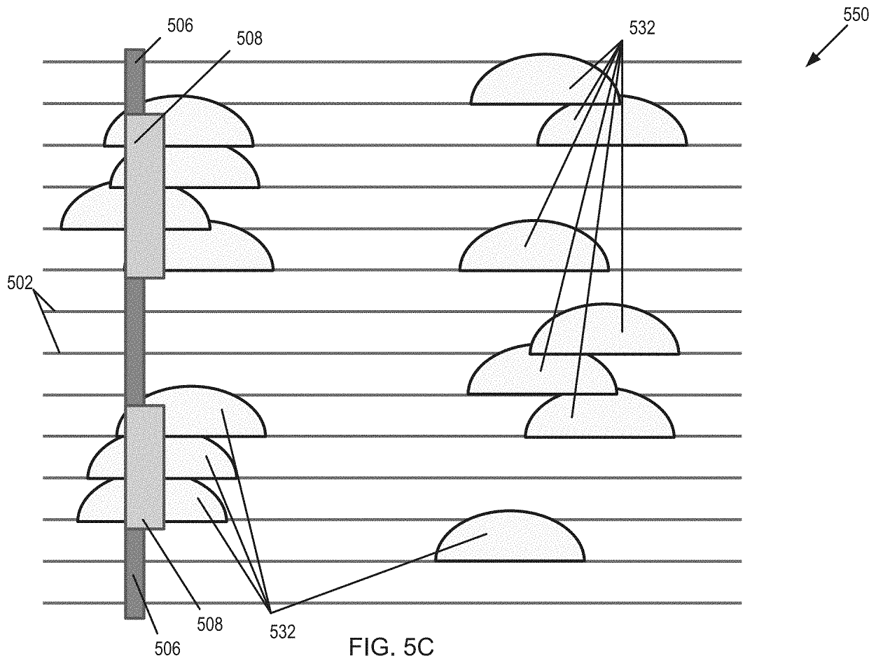

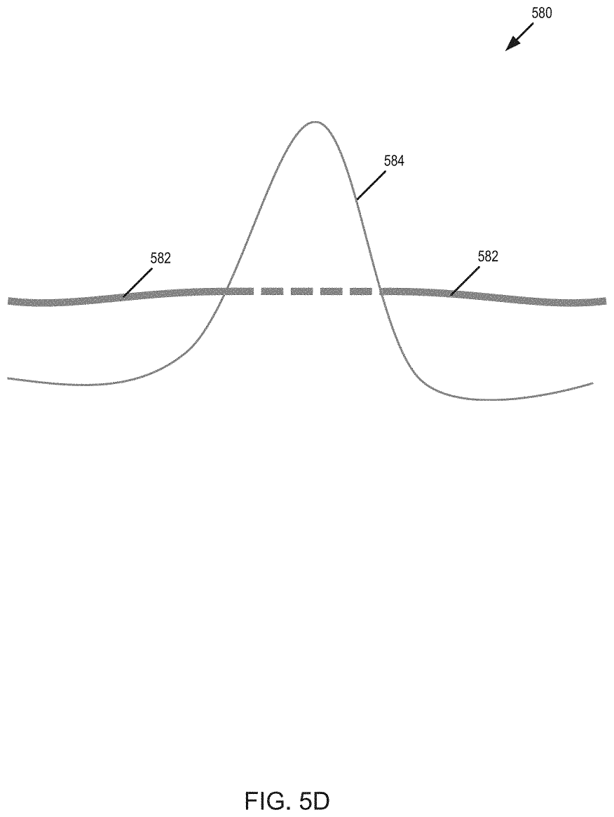

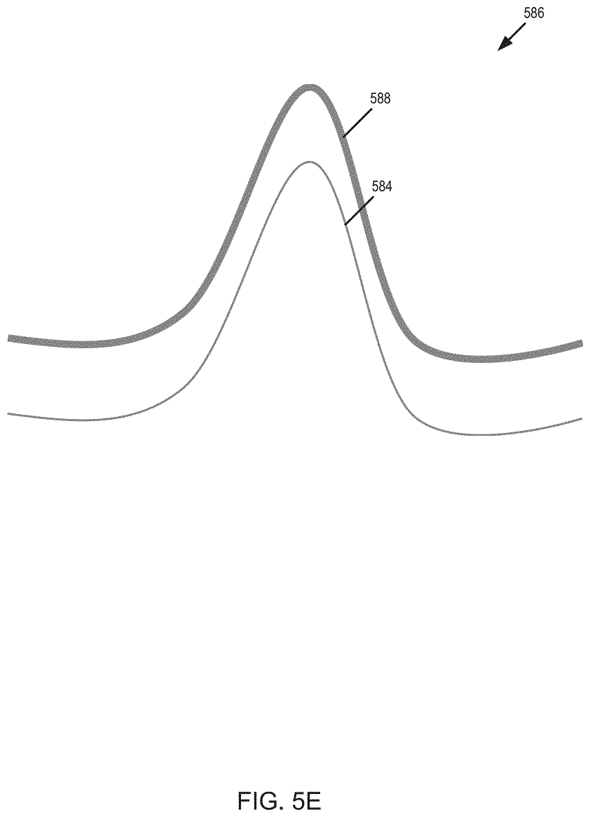

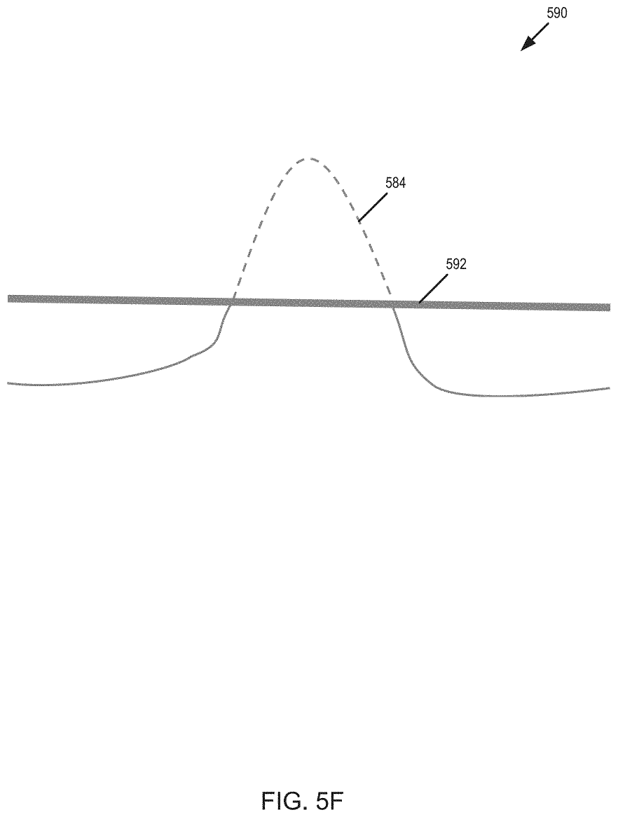

At 312, the element is formed and evaluated. For example, a lobe may be generated based on parameters, transformed to the centerline, and then analyzed using a cost function (e.g., an indicator of the fitness of the instantiation of the lobe with the available data such as well logs, specified trends, or seismic data). At 314, the element may be evaluated for misfit, such as a comparison of the fitness indicator with a predetermined indicator, for example a net non-net indicator. For example, it is determined whether the placement of an element, such as a lobe, is consistent with assumptions. Low or non-net parts of a lobe are consistent with non-net assumptions, but the placement of a high-net channel through a non-net region or placement of a net-lobe or high-net part of a lobe into a non-net region may violate the assumption. Multiple elements may be evaluated. For example, at least ten, at least one hundred, or at least two hundred elements may be evaluated. At 316, it is determined whether to terminate generation of elements to evaluate. In one or some embodiments, termination occurs when all pre-generated centerlines and/or parameter sets have been evaluated. Alternatively, termination occurs when all pre-generated centerlines and/or parameter sets that have not been used already in the current layer have been evaluated. In one or some embodiments, termination criteria include reaching a specified number of evaluations, or finding a specified number of elements that satisfy a specified misfit threshold, e.g., one or five elements whose misfits pass the specified threshold. If element generation is not yet terminated, flow diagram 300 loops back to 304 or 308 in order to instantiate different elements for evaluation. In some embodiments, the misfits 314 are used to update the CenterlineGenerator at 306 and/or ParameterGenerator at 310 before continuation at 304 or 306. If element generation is terminated, at 318, the mud is evaluated. In one embodiment, mud layers with thicknesses specified by the mud trend definition 110 are used. In one or some embodiments, the mud thicknesses are locally reduced by the local element thicknesses, allowing elements to peak through the muds rather than being totally blanketed. In one or some embodiments, the mud layer is converted to a FilITo surface. An example of a FilITo surface is shown as 582 in illustration 580 in FIG. 5D, which may be defined by its elevation, may cover the underlying structure 584, but may also allow the underlying structure 584 to poke through. The FilITo surface 582 shown in illustration 580 is in contrast to the illustration 586 of a drape surface 588 (which may comprise a layer with specified thickness that blankets the underlying structure 584) in FIG. 5E, or to the illustration 590 of an erosional surface 592 (which may be defined by its elevation and clips the underlying structure 584) in FIG. 5F.

At 320, mud misfit is evaluated. Depending on the comparison between element misfits 314 and the mud misfit 320, at 322, the concept model (CM) is updated with the better of element or mud layer. At 324, it is determined whether the elements emplaced in the layer indicate convergence of the layer. In one or some embodiments, the convergence criterion is based on available data, for example reaching the element fraction for the current layer indicated by well, trend, or seismic data. In a preferred embodiment, the layer is deemed to have converged when the mud layer is emplaced at 322 rather than another element. If so, flow diagram 300 loops back to 302 for evaluation of the next layer. If not, flow diagram 300 loops back to 304 or 308 in order to evaluate additional elements. In addition, flow diagram 300 terminates once all layers have been dealt with.

FIG. 3B is a flow diagram 350 of a second implementation of the sequential conditioning depicted in FIG. 2. Flow diagram 350 is similar to flow diagram 300 except for the addition of generating an element in ElementGenerator at 352 and removing 318, 320. The ElementGenerator may produce one kind of element or multiple kinds of elements, e.g., channels, lobes, reefs, and muds. The mud layer may simply be considered to be an element like any other. In one or some embodiments, the ElementGenerator generates the mud layer. In other embodiments, the ElementGenerator does not generate any mud layers and another element may take its role of, e.g., filling space. Furthermore, other elements may be specified for the ElementGenerator such as confined, distributive, or anastomosing channels; lobes, levees, reefs, dunes, mouth bars, etc. In one or some embodiments, the layer is deemed to have converged at 324 when a specified number of elements have been placed onto this layer. Alternatively, the layer is deemed to have converged when specified numbers of specified kinds have been emplaced. In another embodiment, the layer is deemed to have converged when one element of a specified kind has been emplaced. In one or some embodiments, the layer is deemed to have converged when a mud layer has been emplaced.

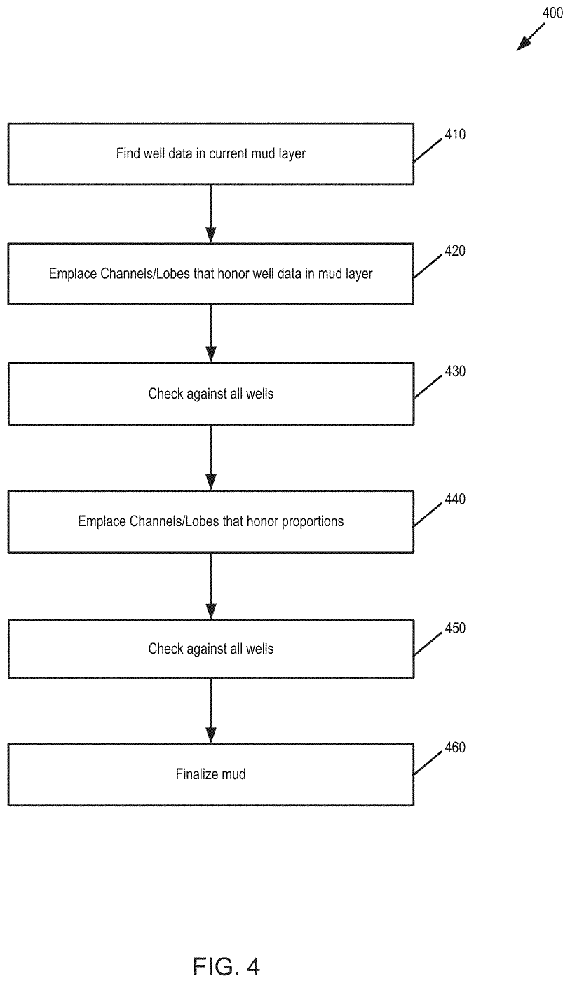

FIG. 4 is a flow diagram 400 of a second example of sequential conditioning. At 410, well data in the current mud layer is found. At 420, one or more elements, such as channels/lobes, are emplaced that honor the well data in the mud layer. At 430, a check is performed against all well data because channel/lobes may intersect a deviated well at locations outside (e.g., above) the current mud layer. At 440, channels/lobes are emplaced that honor proportions that were previously defined. At 450, a check is again performed against all wells. At 460, the mud background is finalized. This second example flow diagram 400 of sequential conditioning first steers channel/lobes in the current layer toward the wells with indication of channel/lobe observation, ensuring that these hard observations are matched. Because elements like channel/lobes may be thicker than the current layer, a channel/lobe candidate could still violate well data above the current layer. Vertical or slightly deviated wells could be matched at 420, but horizontal or severely deviated wells may not penetrate the current layer yet intersect the candidate. Thus, block 430 checks the candidate against all wells to ensure that data from horizontal or severely deviated wells is not violated by the candidate. With 410, 420, and 430, channel/lobes candidates intersect the wells, but if the well spacing is large, then there might be large spatial gaps between channel/lobes, creating a model with channel/lobes lined up on the wells like pearls on strings, under predicting resources and their connectivity. At 440, additional channel/lobes are emplaced as long as they honor the specified proportion trend on the current layer. Yet again, these additional lobes may be penetrated above the current layer by horizontal or severely deviated wells, and thus, at 450 the additional candidates are vetted against these (deviated) wells, or for simplicity, all wells.

FIG. 5A is a depiction 500 of lobes 504 emplaced onto a predefined mud trend via sequentially conditioning bottom-up. The predefined mud trend may be described as a series of layers 502. Different sections of the well are represented by 506 and 508, with 506 representing lower net (e.g., shale) and 508 representing higher net (e.g., porous sand from which hydrocarbons may be obtained). In one or some embodiments, conditioning may commence with a lowest mud layer onto which lobes 504 are placed as needed by well data and seismic data. Thereafter, a next higher mud layer is put on top of the current stack of lobes and muds, and the process may repeat. Various rules may be used in order to determine how to emplace lobes. As one example, one rule comprises interrupting a thin mud layer (FillTo mud layer) rather than running the thin mud layer over a big lobe (mud drape), as can be seen at 510 in FIG. 5A where the mud layers terminate against the yellow lobes. The figure is only a schematic and used for illustration purposes. It appears to indicate that the bases of lobes 504 clip the tops of lobes 504. In one or some embodiments, lobes are conformal to their substrate, following the mud layers or draping onto the lobe below like a stack of pancakes. FIG. 5A further depicts an embodiment where in addition to the well segments 506 and 508, a target lobe fraction of 60% is specified for the model to allow lobe placement away from wells. Starting at the base, the current lobe fraction is 0%, but as the target fraction is 60%, there is opportunity to place a lobe unobserved by the well. In one embodiment, unobserved lobes are placed within the current mud layer while the volumetric lobe fraction the desired fraction is below the target fraction. In another embodiment, unobserved lobed are placed within the current mud layer until the volumetric lobe fraction just exceeds the desired lobe fraction. In the depicted embodiment, the chance of unobserved lobe placement depends on the spread between current volumetric lobe fraction and specified target. The more underfilled (overfilled) the model is with regard to the target, the higher (lower) the chance of lobe placement (rejection). The more overfilled the model is with regard to the specified target, the higher (lower) the chance of lobe rejection (placement). In one embodiment, the amount of overfill or underfill is used to determine a placement/rejection threshold in the range between 0 and 1. Placement or rejection may be decided by drawing a random number from a uniform distribution between 0 and 1 and comparing said number against the current placement/rejection threshold.

In the example of FIG. 5A, lobe placement is influenced by the difference between the actual and the target fraction. Once the first lobe is placed, there is a volumetric fraction mismatch of −10%. The drawn random number was below the placement acceptance threshold, so that no further lobe is considered and the mud layer is filled in. The second mud layer requires placement of a lobe at the well. But with one lobe placed at the well, the current fraction is 50% which is 10% below target. The drawn random number was above the current placement/rejection threshold and another lobe is placed on the second mud layer, raising the current fraction to 75%. The third layer requires placement of a lobe at the well, resulting in a current fraction of 67%, slightly above target. A random number is drawn, compared against the updated placement/rejection threshold, but as this number fell below the threshold, no other lobe is placed and mud layer is filled. The same happens for the fourth layer. For the fifth layer, one lobe is needed at the well and an additional lobe is placed even though the current model is slightly overfilled. The process progresses through the example, ultimately resulting in a final volumetric fraction of 62%.

Details and the amount of final overfill or underfill may be affected by the specifics of converting the current differential to a threshold. In one embodiment, the threshold is 0.5+α(current−target). In another embodiment, the threshold may be the cubic function 0.5+σ(current−target)³ or the logistics function 1/(1+exp(−α. (current−target))). In one embodiment, the more underfilled the current model is, the higher the chance of lobe placement; and the more overfilled the current model is, the lower the chance of lobe placement. In another embodiment, the threshold is formed such as to place additional lobes until the current fraction exceeds the desired layer fraction.

FIG. 5B is a first depiction 530 of channels 532 emplaced onto a predefined mud trend via sequentially conditioning top-down. Unlike lobes, which are placed onto the mud layer, channels scour or bore into a respective mud layer. Further, channels are unlike lobes, which when stacked are additive in nature. Channels may overlap. In particular, an earlier, deeper-located channel can be eroded or even removed by a later, shallower-located channel. A later channel can (partially) remove earlier one. Lobes are mutually exclusive, at any location, as there may only be one lobe. Conversely channels are not mutually exclusive; over time, the same location may be occupied by multiple channels with the last one persisting. In one embodiment for the conditioning of channel elements, sequential conditioning 150 iterates through the layers top-down, which encourages placement of large channels with less rework or channels eroding each other. In one embodiment for channel conditioning, sequential conditioning 150 iterates over the layers bottom-up as described for lobes, which forces new channels to be placed in each layer resulting in excessive rework and channels eroding into each other. The final model realization 170 may be formed bottom-up to honor geologic sequencing and cross-cutting relationships, independent whether sequential conditioning found elements and their parameters bottom-up or top-down.

FIG. 5C is a second depiction 550 of channels 532 emplaced onto a predefined mud trend via sequentially conditioning bottom-up by flipping the z-axis. In this regard, a 180° rotation or reversal of the z-axis results in channels 532 being flipped so that sequential conditioning may be performed from the bottom-upward, such as performed in FIG. 5A. Thus, in one embodiment, sequential conditioning of channels is performed by iterating over the layers from the top-down but replaying them in reverse order when forming the final model. In another embodiment, sequential conditioning of channels is performed by flipping the z-axis, iterating over the layers from the bottom-up in the flipped coordinate frame and replaying them in the found order but in the original coordinate frame when forming the final model.

As discussed above, lobes may be viewed as accumulated, stacking on top of each other, for conditioning from the bottom upward. In contrast, channels may be viewed as eroding or digging into each other, for conditioning from the top downward. In one or some embodiments, the functional form is configured so that lobes/channels are tightly coupled. In such a functional form, the direction of conditioning may be dependent on which element (lobe or channel) dominates. As one example, for a lobe-dominated subsurface (e.g., the volume of the lobes is greater than the volume of the channels), conditioning may be performed from bottom layers upward (though the channels may not be as well conditioned). As another example, for a channel-dominated subsurface, conditioning may be performed from the top layers downward (though the lobes may not be as well conditioned). Independent of dominant element, it may still be advantageous to condition bottom up in the original coordinate frame for all elements (including erosive channels) because the true geologic placement order and interaction order is preserved.

FIG. 6 is a depiction 600 of an exemplary concept model 602, mud trend, proportion trend, and wells 604 formed from concept model 602, and a plurality of candidate lobes 606, 608, 610, 612 that may be compatible with the mud trend, proportion trend, and wells. As discussed above, various candidate objects, such as candidate lobes, may be analyzed in order to select the best of those analyzed in order to determine whether to emplace it in the specific mud layer. In particular, responsive to analyzing misfit of the candidates, the candidates may be emplaced, or alternative candidates may be generated for further analysis. By looping over the layers of the mud trend and performing these steps, one or multiple models can be found that honor the data from mud trend, proportion trend, and wells 604 and resemble the concept model 602.

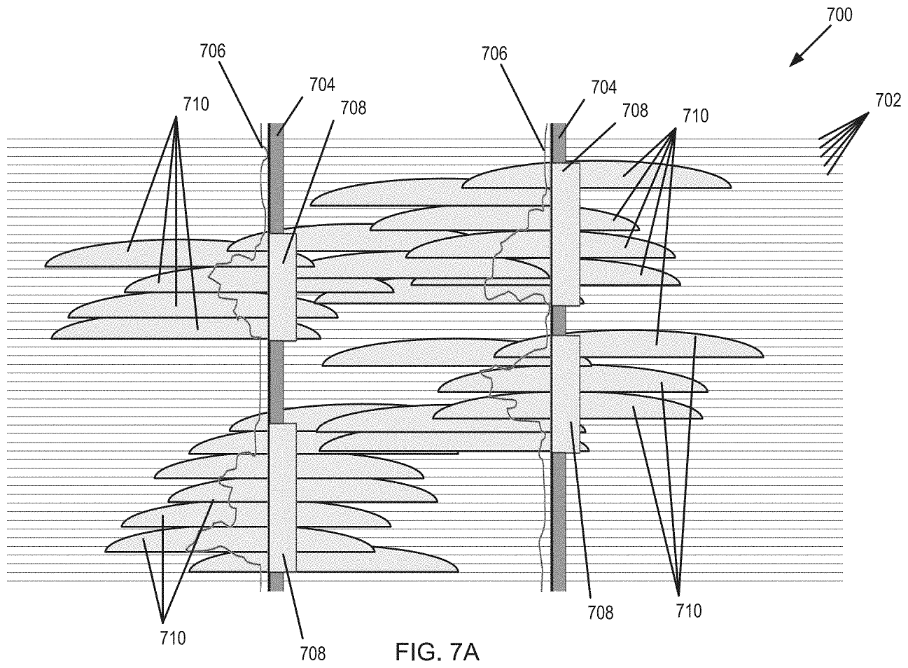

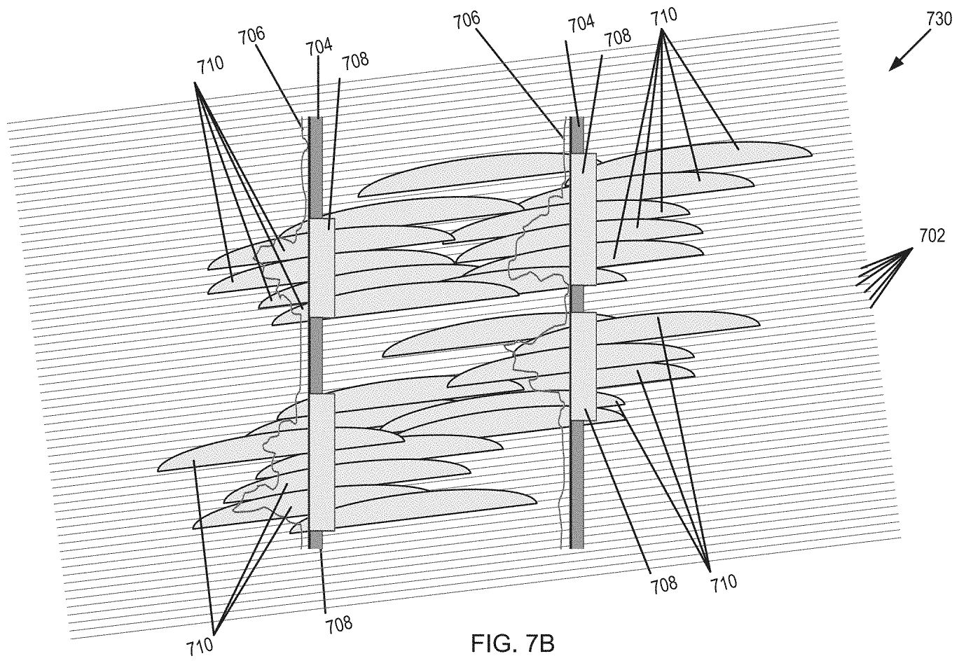

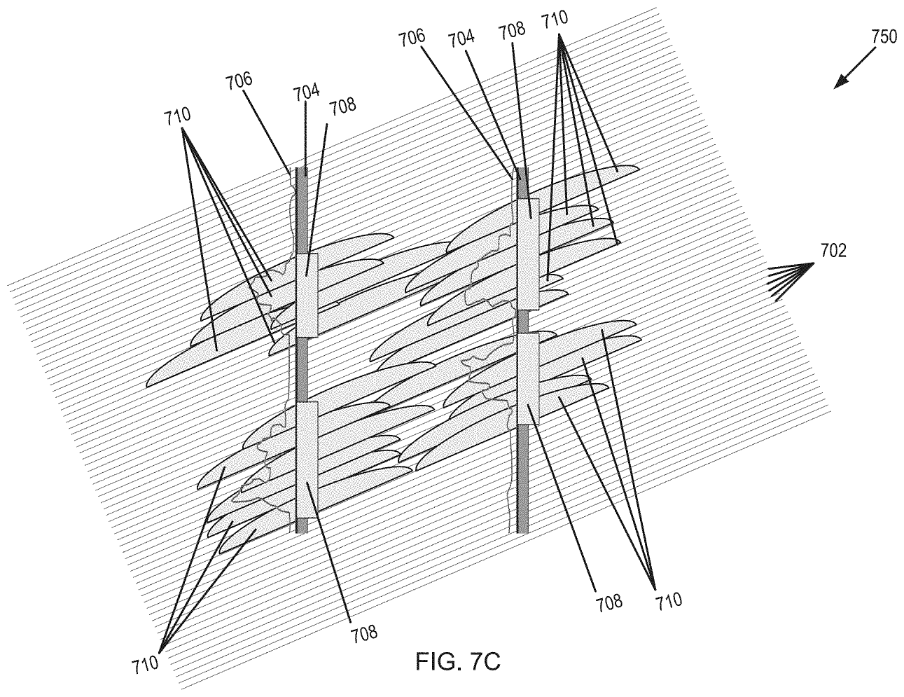

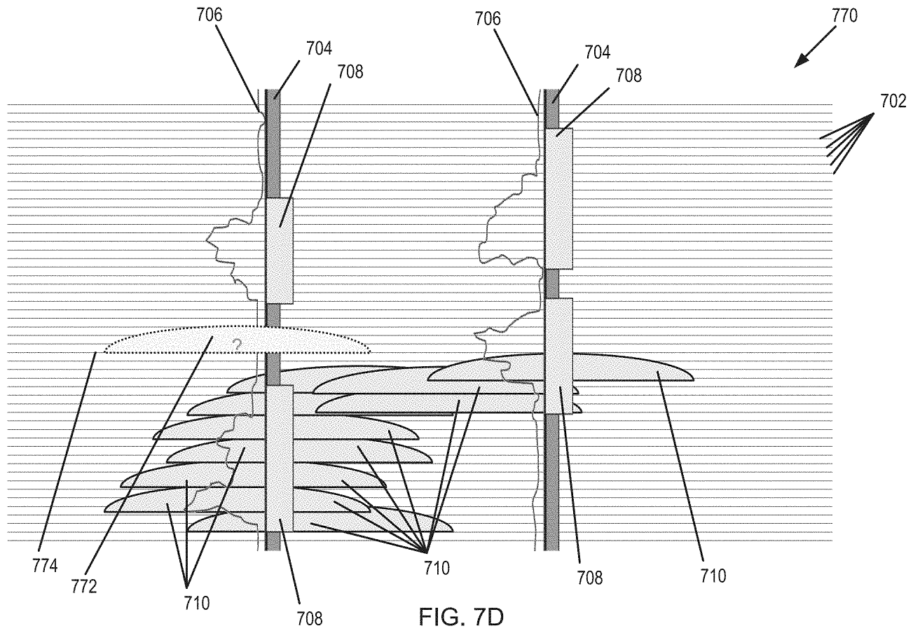

FIG. 7A is a first depiction 700 of the mud layers 702 and lobes. Line 706 represents data indicative of a net proxy well log whereby a line further away from the well is indicative of higher net (sand) and closer to the well is indicative of lower net (shale). Thus, based on line 706, the well may be divided, segmented or blocked into sections 704 and sections 708, with sections 704 representing lower net (shale) and sections 708 representing higher net (sand). Further, high-net lobes 710 may emanate from high-net sections 708, the high-net lobes being an explanation for the observance well of logs indicating higher net. As shown in FIG. 7A, the mud layers 702 have a flat orientation and uniform thickness. In contrast, FIG. 7B is a second depiction 730 of the mud layers and lobes 710, where the mud layers are not horizontal (e.g., at least 15° tilt) and have uniform thickness. Due to the change in the mud layers 702 depicted in FIG. 7B, the lobes 710 emplaced are different from the lobes emplaced in FIG. 7A. Likewise, FIG. 7C is a third depiction 750 of the mud layers 702 (with a more tilted orientation than FIG. 7B and uniform thickness) and lobes 710. FIG. 7D is a fourth depiction 770 of the mud layers 702 (with a flat orientation and uniform thickness) and lobes 710. FIG. 7D depicts sequential conditioning to determine whether to emplace lobe 772 at mud layer 774, after the lower layers have been conditioning, previously emplacing lobes 710.

As shown in FIGS. 7A-7D, certain lobes 710 sit on the mud layers 702. In this regard, the bottom surface of the lobes 710 that are emplaced or sit on the mud layers 702 follow the orientation of the mud layers 702 (e.g., a flat orientation of the mud layers 702 results in a flat orientation of the lobes 710). Further, additional lobes 710 that are positioned on top of the lobes that sit on the mud layers 702 will, in turn, follow the orientation of the mud layers 702. In this regard, the mud layers, including the orientation and/or the thickness of the mud layers, may impact the placement of the elements, including the lobes and/or the channels. While FIGS. 7A-7D depict the same well data, the models differ due to the differing mud trends. The number of lobes 710 is similar for each of FIGS. 7A-7D. Thus the amount of resource present in each of FIGS. 7A-7D is similar. But producibility may differ as connectivity differs. The different trends will cause the lobes to connect to each other differently, causing different connectivity patterns and scenarios.

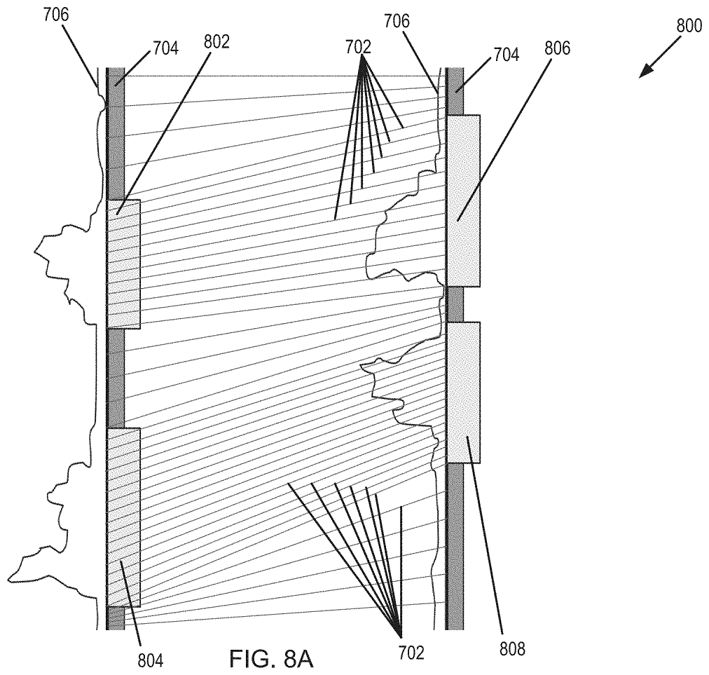

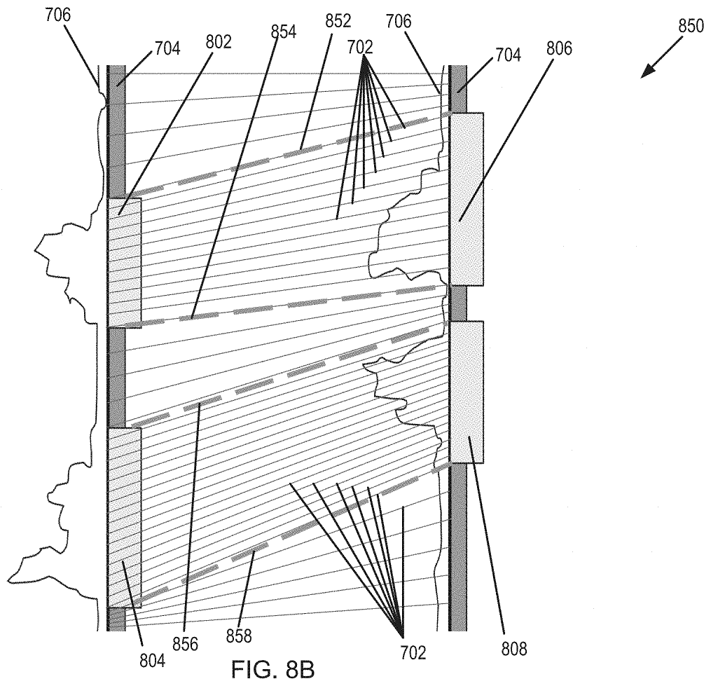

As discussed above, in one or some embodiments, the mud layers may have in different sections any one, any combination, or all of: uniform thickness and flat orientation; uniform thickness and tilted orientation; non-uniform thickness and flat orientation; and non-uniform thickness and tilted orientation. A mud layer may have finite thickness in one location and vanish in another one. In particular, different regions of subsurface may have mud layers that exhibit different properties. For example, a first section of the subsurface may have non-uniform thickness and flat orientation and a second section of the subsurface may have uniform thickness and flat orientation. As another example, a first section of the subsurface may have uniform thickness and a tilted orientation and a second section of the subsurface may have non-uniform thickness and a titled orientation. In this regard, it is contemplated that the subsurface may have at least one, at least two, at least three, etc. different combinations of mud layer properties. FIG. 8A is a depiction 800 of one example of the mud layers 702 with varying orientation and non-uniform thickness (e.g., varying thickness and/or orientation across multiple mud layers). FIG. 8B is another depiction 850, similar to that illustrated in FIG. 8A, with additional dashed lines 852, 854, 856, 858 to highlight the changes in the mud layers. As shown, higher net sections 802 and 806 share common mud layers (highlighted by lines 852, 854) and higher net sections 804 and 808 share common mud layers (highlighted by lines 856, 858). Alternatively, higher net section 804 may share common mud layers with higher net section 806. Regardless, FIGS. 8A-8B illustrate the varying mud layers on which sequential conditioning may be based.

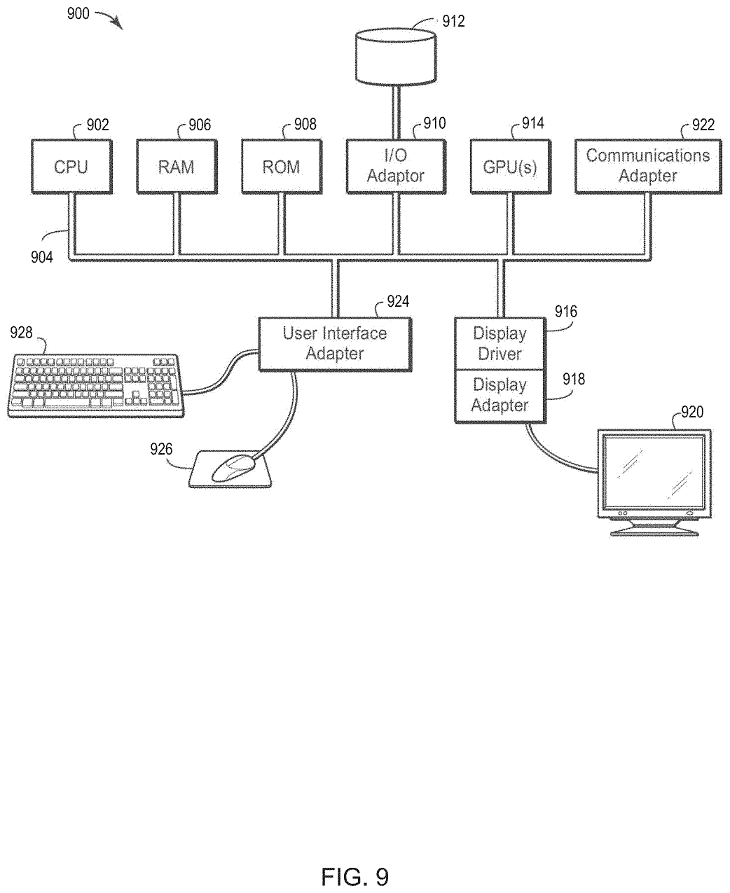

In all practical applications, the present technological advancement must be used in conjunction with a computer, programmed in accordance with the disclosures herein. For example, FIG. 9 is a diagram of an exemplary computer system 900 that may be utilized to implement methods described herein. A central processing unit (CPU) 902 is coupled to system bus 904. The CPU 902 may be any general-purpose CPU, although other types of architectures of CPU 902 (or other components of exemplary computer system 900) may be used as long as CPU 902 (and other components of computer system 900) supports the operations as described herein. Those of ordinary skill in the art will appreciate that, while only a single CPU 902 is shown in FIG. 9, additional CPUs may be present. Moreover, the computer system 900 may comprise a networked, multi-processor computer system that may include a hybrid parallel CPU/GPU system. The CPU 902 may execute the various logical instructions according to various teachings disclosed herein. For example, the CPU 902 may execute machine-level instructions for performing processing according to the operational flow described.

The computer system 900 may also include computer components such as non-transitory, computer-readable media. Examples of computer-readable media include computer-readable non-transitory storage media, such as a random access memory (RAM) 906, which may be SRAM, DRAM, SDRAM, or the like. The computer system 900 may also include additional non-transitory, computer-readable storage media such as a read-only memory (ROM) 908, which may be PROM, EPROM, EEPROM, or the like. RAM 906 and ROM 908 hold user and system data and programs, as is known in the art. The computer system 900 may also include an input/output (I/O) adapter 910, a graphics processing unit (GPU) 914, a communications adapter 922, a user interface adapter 924, a display driver 916, and a display adapter 918.

The I/O adapter 910 may connect additional non-transitory, computer-readable media such as storage device(s) 912, including, for example, a hard drive, a compact disc (CD) drive, a floppy disk drive, a tape drive, and the like to computer system 900. The storage device(s) may be used when RAM 906 is insufficient for the memory requirements associated with storing data for operations of the present techniques. The data storage of the computer system 900 may be used for storing information and/or other data used or generated as disclosed herein. For example, storage device(s) 912 may be used to store configuration information or additional plug-ins in accordance with the present techniques. Further, user interface adapter 924 couples user input devices, such as a keyboard 928, a pointing device 926 and/or output devices to the computer system 900. The display adapter 918 is driven by the CPU 902 to control the display on a display device 920 to, for example, present information to the user such as subsurface images generated according to methods described herein.

The architecture of computer system 900 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 900 may include various plug-ins and library files. Input data may additionally include configuration information.

Preferably, the computer is a high performance computer (HPC), known to those skilled in the art. Such high performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon.

The above-described techniques, and/or systems implementing such techniques, can further include hydrocarbon management based at least in part upon the above techniques, including using the one or more generated geological models in one or more aspects of hydrocarbon management. For instance, methods according to various embodiments may include managing hydrocarbons based at least in part upon the one or more generated geological models and data representations (e.g., seismic images, feature probability maps, feature objects, etc.) constructed according to the above-described methods. In particular, such methods may include drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well. For example, the different stages of exploration may result in data being generated in the respective stages, which may be iteratively used by the machine learning to generate the one or more geological models discussed herein.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

The following example embodiments of the invention are also disclosed:

Embodiment 1: A computer-implemented method of conditioning surface-based geologic models of a subsurface, the method comprising: accessing an indication of a plurality of mud layers in the subsurface; conditioning, using the indication of the plurality of mud layers, by emplacing at least one of lobes or channels; and building a model based on the conditioning.

Embodiment 2: The method of Embodiment 1, wherein conditioning comprises sequential conditioning, using the indication of the plurality of mud layers, by emplacing at least one of lobes or channels at least partially layer by layer; and wherein the model is build based on the sequential conditioning.

Embodiment 3: The method of Embodiments 1 or 2, wherein the indication of the plurality of mud layers defines thickness and orientation of the plurality of mud layers.

Embodiment 4: The method of Embodiments 1-3, wherein the thickness of the mud layers varies across the plurality of mud layers.

Embodiment 5: The method of Embodiments 1-4, wherein the orientation of the mud layers varies across the plurality of mud layers.

Embodiment 6: The method of Embodiments 1-5, wherein the indication of a plurality of mud layers comprises a surface-based model with one or more properties comprising at least one of target or actual channel/lobe fractions, environment of deposition, sub environments, or facies.

Embodiment 7: The method of Embodiments 1-6, wherein sequentially conditioning comprises: realizing one or more elements for emplacing on a respective layer; determining whether there is convergence for the emplaced one or more realized elements for the respective mud layer; and responsive to determining that there is convergence for the emplaced one or more realized elements for the respective mud layer, iterating to a next respective mud layer for sequential conditioning.

Embodiment 8: The method of Embodiments 1-7, wherein the next respective mud layer, relative to the respective mud layer, is positioned closer to a surface of the subsurface so that sequential conditioning is performed bottom upward.

Embodiment 9: The method of Embodiments 1-8, wherein the next respective mud layer is directly on top of the respective mud layer.

Embodiment 10: The method of Embodiments 1-9, wherein realizing the one or more elements comprises: using a template definition in order to specify values of a functional form indicative of channels or lobes, thereby generating a plurality of candidate elements for emplacing; and using a position definition in order to place the plurality of candidate elements.

Embodiment 11: The method of Embodiments 1-10, wherein the position definition comprises a centerline definition in order to define centerlines for the plurality of candidate elements.

Embodiment 12: The method of Embodiments 1-11, wherein the centerline definition comprises using a centerline generator in order to automatically generate the centerlines for the plurality of candidate elements, the centerline generator using a specification of start or finish lines, a specification of fairways, target points for intersection, or drawing/repulsing centerlines for areas on a map.

Embodiment 13: The method of Embodiments 1-12, wherein realizing the one or more elements for emplacing on a respective layer further comprises: assessing the plurality of candidate elements with a cost function in order to generate an indication of realization of the plurality of candidates with at least one of wireline data, seismic data, or desired target fraction; and determining whether the emplace the plurality of candidate elements based on the assessment of the plurality of candidate elements.

Embodiment 14: The method of Embodiments 1-13, wherein determining whether to emplace the plurality of candidate elements based on the assessment of the plurality of candidate elements comprises selecting for emplacement a best candidate element from the plurality of candidate elements.

Embodiment 15: The method of Embodiments 1-14, wherein determining whether to emplace the plurality of candidate elements based on the assessment of the plurality of candidate elements comprises selecting respective candidate elements whose indication generated by the cost function is less than a specified cost threshold.

Embodiment 16: The method of Embodiments 1-15, wherein realizing the one or more elements comprises: using functional form to realize the one or more elements, the functional form augmented with sub environments of deposition in order to define an internal, local coordinate system tied to the functional form.

Embodiment 17: The method of Embodiments 1-16, wherein determining whether there is convergence for the emplaced one or more realized elements for the respective mud layer comprises analyzing proportion trends, the proportion trends comprising definition of fractions or densities of lobes, channels, and muds.

Embodiment 18: The method of Embodiments 1-17, further comprising, after sequentially conditioning layer by layer, performing global optimization across multiple layers; and wherein the model is built based on the sequential conditioning and the global optimization.

Embodiment 19: The method of Embodiments 1-18: wherein the model is built based on the sequential conditioning layer by layer but not global optimization across multiple layers.

Embodiment 20: The method of Embodiments 1-19: wherein sequential conditioning is performed using a reinforcement learning algorithm.

Embodiment 21: The method of Embodiments 1-20: wherein the model comprises model properties; and further comprising performing geostatistical property population in order to encode high-frequency perturbations resident in observed wireline or seismic data in the model properties of the model.

Embodiment 22: The method of Embodiments 1-21, further comprising managing hydrocarbons in the subsurface based on the model.

Embodiment 23: The method of Embodiments 1-22, further comprising: generating at least one of result data, tables, spreadsheets, or an image based on the model; and outputting the at least one of the result data, the tables, the spreadsheets, or the image on a display.

1. A computer-implemented method of conditioning surface-based geologic models of a subsurface, the method comprising:
accessing an indication of a plurality of mud layers in the subsurface;
conditioning, using the indication of the plurality of mud layers, by emplacing at least one geologic body; and
building a model based on the conditioning.

2. The method of claim 1, wherein the at least one geologic body comprises one or more of channels, lobes, levees, spills, overbank deposits, deltas, beaches, bars, clinoforms, marches, dunes, tidal flats, lagoons, reefs, and fans.

3. The method of claim 1, wherein the at least one geologic body comprises at least one channel or lobe.

4. The method of claim 1, wherein the indication of the plurality of mud layers defines thickness and orientation of the plurality of mud layers.

5. The method of claim 3, wherein the thickness of the mud layers varies across the plurality of mud layers.

6. The method of claim 4, wherein the orientation of the mud layers varies across the plurality of mud layers.

7. The method of claim 1, wherein the indication of a plurality of mud layers comprises a surface-based model with one or more properties comprising at least one of target or actual geologic body fractions, environment of deposition, sub environments, or facies.

8. The method of claim 1, wherein conditioning comprises sequential conditioning, using the indication of the plurality of mud layers, by emplacing at least one of geologic bodies at least partially layer by layer; and
wherein the model is build based on the sequential conditioning.

9. The method of claim 8, wherein sequentially conditioning comprises:
realizing one or more elements for emplacing on a respective layer;
determining whether there is convergence for the emplaced one or more realized elements for the respective mud layer; and
responsive to determining that there is convergence for the emplaced one or more realized elements for the respective mud layer, iterating to a next respective mud layer for sequential conditioning.

10. The method of claim 9, wherein the next respective mud layer, relative to the respective mud layer, is positioned closer to a surface of the subsurface so that sequential conditioning is performed bottom upward.

11. The method of claim 9, wherein the next respective mud layer is directly on top of the respective mud layer.

12. The method of claim 9, wherein realizing the one or more elements comprises:
using a template definition in order to specify values of a functional form indicative of the geologic body, thereby generating a plurality of candidate elements for emplacing; and
using a position definition in order to place the plurality of candidate elements.

13. The method of claim 12, wherein the position definition comprises a centerline definition in order to define centerlines for the plurality of candidate elements.

14. The method of claim 12, wherein the centerline definition comprises using a centerline generator in order to automatically generate the centerlines for the plurality of candidate elements, the centerline generator using a specification of start or finish lines, a specification of fairways, target points for intersection, or drawing/repulsing centerlines for areas on a map.

15. The method of claim 9, wherein realizing the one or more elements for emplacing on a respective layer further comprises:
assessing the plurality of candidate elements with a cost function in order to generate an indication of realization of the plurality of candidates with at least one of wireline data, seismic data, or desired target fraction; and
determining whether the emplace the plurality of candidate elements based on the assessment of the plurality of candidate elements.

16. The method of claim 15, wherein determining whether to emplace the plurality of candidate elements based on the assessment of the plurality of candidate elements comprises selecting for emplacement a best candidate element from the plurality of candidate elements.

17. The method of claim 15, wherein determining whether to emplace the plurality of candidate elements based on the assessment of the plurality of candidate elements comprises selecting respective candidate elements whose indication generated by the cost function is less than a specified cost threshold.

18. The method of claim 9, wherein realizing the one or more elements comprises:
using functional form to realize the one or more elements, the functional form augmented with sub environments of deposition in order to define an internal, local coordinate system tied to the functional form.

19. The method of claim 9, wherein determining whether there is convergence for the emplaced one or more realized elements for the respective mud layer comprises analyzing proportion trends, the proportion trends comprising definition of fractions or densities of lobes, channels, and muds.

20. The method of claim 1, wherein the model comprises model properties; and
further comprising performing geostatistical property population in order to encode high-frequency perturbations resident in observed wireline or seismic data in the model properties of the model.
